(19) United States
(12) Patent Application Publication
(10) Pub. No.: US 2020/0401101 A1
(43) Pub. Date: Dec. 24, 2020

(54) DEVICE AND METHOD FOR VISUALIZING OR ASSESSING A PROCESS STATE

(71) Applicant: ENGEL AUSTRIA GmbH, Schwertberg (AT)

(72) Inventors: Josef GIESSAUF, Perg (AT); Herwig KOPPAUER, Linz (AT)

(21) Appl. No.: 16/904,838

(22) Filed: Jun. 18, 2020

(30) Foreign Application Priority Data
Jun. 19, 2019 (AT) A 50551/2019

(51) Int. Cl. G05B 19/406; G06F 16/28

(52) U.S. Cl. CPC G05B 19/406; G05B 2219/45204; G06F 16/287

(57) ABSTRACT

A device for monitoring a production facility includes a computing unit, at least one sensor, a memory unit, and an output device. In the memory unit, in each of at least one process variable set, at least three possible process states are stored and at least one algorithm is stored by which the one of the different possible process states actually present can be calculated, the possible process states that differ in relation to the respective process variable set are classified according to whether measures are necessary or recommended, the commands by the computing unit prompt it to execute the associated algorithm and thus to calculate which of the different possible process states is actually present and to check whether the actually present process state is classified as such a process state, to generate and output an electronic message depending on the calculated process state.

The invention relates to a device for monitoring a production facility with the features of the preamble of claim 1 as well as to a production facility with such a device. The invention furthermore relates to a computer program product. Finally, the invention relates to a method for monitoring a production facility containing a moulding machine functioning in moulding cycles and optionally at least one peripheral device.

DE 10 2007 013 044 B4 reveals a generic device which displays a warning signal on a display device when a threshold value is exceeded by a stability parameter.

A further generic device is also revealed by DE 10 2004 052 499 A1, which uses an algorithm which generates a message giving information about a process state when an actual parameter value exceeds the associated limit value.

A further generic device is revealed by US 2010/0295199, which improves energy consumption and/or melt quality, wherein current process parameters allocated to the melt are compared with set values. In the case of a particular deviation the machine setting parameters are adjusted in order to optimize energy consumption or to improve melt quality. The process parameters are displayed on a screen.

Within the framework of the present disclosure, the term process state in the context of a production facility is dependent on the status of the parameters which participate directly and/or indirectly in the manufacturing process and reflects the situation of the production facility with respect to at least one parameter during the manufacturing process running in moulding cycles. The term process state can relate only to the moulding machine of the production facility, only to the optionally present at least one peripheral device or to both the moulding equipment and the at least one peripheral device. Within the framework of the present disclosure, any reference to a production facility can be understood as a reference only to the moulding machine of the production facility, only to the optionally present at least one peripheral device or to both the moulding equipment and the at least one peripheral device.

The process state within the meaning of the invention comprises e.g.:
the quality of the process setting: target values are chosen such that
   the process is robust vis-à-vis environmental influences
   they are also or can also be actually achieved
   they are suitable with regard to the material processed
the state of elements of the production facility (e.g. the non-return valve, the mould, etc.)
the state of the material processed
the influence of unmeasured disturbance variables (e.g. ambient temperature, draughts, etc.).

The state of the art has the disadvantage that the known algorithms for determining the process state use a limited number of parameters and do not guarantee a possibility of calculating complex relationships between process states and the associated parameters, as well as only allowing limited conclusions as to the causes of the process states.

The object of the invention is to provide a generic device, production facility and a computer program product as well as a generic monitoring method in which the problems discussed above are remedied.

This object is achieved by a device with the features of claim 1, a production facility with the features of claim 19, a computer program product with the features of claim 20 and a method with the features of claim 21. Advantageous embodiments of the invention are defined in the dependent claims.

Because, in a memory unit which is in or can be brought into data connection with the computing unit,
in relation to at least one process variable set, comprising at least two different process variables of the production facility or at least one process variable with at least one derived variable, in each case at least three possible process states of the production facility are stored and, in relation to each process variable set, at least one algorithm is stored by which, using actual values of at least two process variables or one actual value of at least one process variable and one actual value of at least one derived variable and at least one additional parameter which is different from the actual value of the respective process variable and from the actual value of the respective derived variable, it can be calculated which of the possible process states that differ in relation to the respective process variable set is actually present,
the possible process states that differ in relation to the respective process variable set are classified according to whether measures which bring about an alteration of at least one process variable and/or at least one derived variable are necessary or recommended, wherein, in relation to each process variable set, at least one process state is classified such that no measures are necessary or recommended and at least one process state is classified such that measures are necessary or recommended,
the commands during the execution of the computer program by the computing unit prompt it
   to execute, in relation to the respective process variable set, the associated at least one algorithm and thus, taking into account the actual values of the at least two process variables or the actual value of the at least one process variable and the actual value of the respective derived variable and the at least one additional parameter, to calculate which of the possible process states that differ in relation to the respective process variable set is actually present and
   to check whether the actually present process state is classified as such a process state for which a measure which brings about an alteration of the respective process variable set is necessary or recommended,
   for the case where a measure is necessary or recommended in relation to the actually present process state because of its classification, to generate an electronic message depending on the calculated process state and to output it by means of the output device, wherein it is preferably provided that the electronic message contains an item of information as to which of the possible process states that differ in relation to the process variable set is actually present,
      it is first made possible, taking into account the at least one process variable set and the at least one underlying algorithm, to classify at least one actually present process state such that measures in relation to the at least one process state can be shown and items of information regarding the actually present process state are output.

The generation of the required algorithms can be effected by experts at the manufacturer of the production facility using their specialist knowledge and optionally using the results of tests, simulations and/or calculations or through the use of an artificial intelligence.

In general, one process variable set (more precisely: the actual values thereof) is allocated to each moulding cycle.

The term “process variable set” is to be understood as a short term for “at least two different process variables of the production facility or at least one process variable with at least one derived variable” and need not be present as an identifiable data set. This applies to the entire disclosure.

The determination of the required actual values, optionally the at least one derived variable, and the execution of the algorithm are preferably effected in relation to one moulding cycle, particularly preferably in relation to all moulding cycles or in relation to selected moulding cycles.

The actually present process state is displayed to the user of the device, of the computer program product and of the method via the item of information of the electronical message in a form in which the user need not take into account the underlying parameters of the process variable set. The user recognizes at a glance, represented in a compact manner, which process state is actually present, without having to interpret process variables, derived variables, actual values or additional variables.

The electronic message can contain potential explanations or instructions for the user. In the generation of the instructions, the invention can also consider potential effects of a change in the process setting on relevant process parameters, such as e.g. cycle time, and primarily give those instructions which have no influence on relevant process parameters.

Furthermore, during the execution of the computer program (preferably in every moulding cycle or only in selected moulding cycles) the calculation and classification of the actually present process state as well as the generation of an electronic message regarding the classification of the at least one actually present process state are made possible.

An advantage here is that the at least one process variable set is described by the at least one algorithm such that complex relationships between the at least two different process variables of the production facility and/or the at least one process variable with at least one derived variable can be monitored and/or are brought into connection with the actual value of the respective process variable.

An electronic message can thereby be generated not only when a threshold value is exceeded, but rather the device offers the possibility of describing the process variable set through a process state and giving information about this process state.

Through the production facility with a moulding machine functioning in moulding cycles and a monitoring device, the user thus has detailed items of information regarding the process states and the associated process variables and/or derived variables.

Furthermore, items of information regarding additional parameters, actual values of the process variables and/or of the derived variables as well as events can be prepared for the user.

Because the computer program product comprises commands which, when executed by a computing unit of a production facility containing a moulding machine functioning in moulding cycles and optionally at least one peripheral device, prompt it (preferably in every moulding cycle or only in selected moulding cycles),
from a memory unit which is in or can be brought into data connection with the computing unit, in relation to at least one process variable set of the production facility, to retrieve in each case at least three possible process states of the production facility and, in relation to each process variable set, to retrieve the at least one algorithm by which, using actual values of at least two process variables or one actual value of at least one process variable and one actual value of at least one derived variable and at least one additional parameter which is different from the actual value of the respective process variable and from the actual value of the respective derived variable, it can be calculated which of the possible process states that differ in relation to the respective process variable set is actually present, wherein the possible process states that differ in relation to the respective process variable set are classified according to whether measures which bring about an alteration of the respective process variable and/or derived variable are necessary or recommended, wherein, in relation to each process variable set, at least one process state is classified such that no measures are necessary or recommended and at least one process state is classified such that measures are necessary or recommended,
in relation to at least one process variable set, to execute the associated at least one algorithm and thus, taking into account the actual values of the at least two process variables or the actual value of the at least one process variable and the actual value of the at least one derived variable and at least one additional parameter, to calculate which of the possible process states that differ in relation to the respective process variable set is actually present and
to check whether the actually present process state is classified as such a process state for which a measure which brings about an alteration of the respective process variable and/or derived variable is necessary or recommended,
for the case where a measure is necessary or recommended in relation to the actually present process state because of its classification, to generate an electronic message depending on the calculated process state and to output it by means of the output device, wherein it is preferably provided that the electronic message contains an item of information as to which of the possible process states that differ in relation to the process variable set is actually present,
   the necessary items of information are, conveniently for the user, automatically used from the memory unit for the calculation and prepared such that the data resulting therefrom can be presented to the user in a form such that a time saving in the analysis and manipulation of process states is guaranteed.

In relation to the monitoring method, it is provided according to the invention that, by means of a computing unit,
in relation to at least one process variable set of the production facility, taking into account actual values of at least two process variables or one actual value of at least one process variable and one actual value of at least one derived variable and at least one additional parameter, it is calculated which of the possible process states that differ in relation to the respective process variable set is actually present and
it is checked whether the actually present process state is classified as such a process state for which a measure which brings about an alteration of the respective process variable and/or derived variable is necessary or recommended,
for the case where a measure is necessary or recommended in relation to the actually present process state because of its classification, to generate an electronic message depending on the calculated process state and to output it by means of the output device, wherein it is preferably provided that the electronic message contains an item of information as to which of the possible process states that differ in relation to the process variable set is actually present.

It is thereby made possible for the actually present process state to be determined by taking into account the actual value of the respective process variable and/or the actual value of the respective derived variable of the process variable set.

In addition, checking the classification and passing information on to the user of the device are guaranteed.

Quite generally, there is no need to assign a process state to every process variable and/or derived variable.

In an embodiment example of the invention, it is provided that the electronic message contains an item of information as to:
which measure is necessary or recommended and/or
which of the possible process states that differ in relation to the process variable set is actually present.

It is thereby made possible to inform the user, for example, how the at least one actually present process state can be acted on.

The measures relate to the at least one actually present process state and give items of information regarding the manipulation of the at least one actually present process state.

An electronic message makes it possible to visualize the data and offers a user-friendly handling of the device through the preparation of the data, as it can be recognized which process state is actually present and optionally which measures are to be taken.

The items of information from the calculation step are prepared through the visualization such that it is clearly obvious to the user which process state is present and with which measures this process state can be acted on. In an embodiment example the electronic message can be transmitted to stored addresses (e.g. email addresses).

In an embodiment example, the electronic message can bring about an automatic response to a machine control of the production facility, e.g. an automatic change in target values of process variables or an interruption in production.

In an embodiment example, the electronic message can contain at least one link, via which the user arrives at a screen page of the output device or at an input field for a target value, where it is possible to remedy a recognized problem.

In an embodiment example, the electronic message can be saved for a later tracing.

In an embodiment example, the electronic message can be transmitted to at least one other production facility and used in the at least one other production facility to pre-emptively avoid an unfavourable state.

In an embodiment example of the invention, it is provided that at least one additional parameter and/or at least one process variable and/or at least one derived variable from at least one preceding moulding cycle can be used for the execution of the at least one algorithm.

It is thereby made possible to take into account and/or prepare a temporal progression of the at least one additional parameter and/or the at least one process variable and/or the at least one derived variable.

According to this embodiment example, this temporal progression is used for the calculation of the at least one process state in order to make a more precise classification and/or diagnosis of the actually present process state possible.

In an embodiment example of the invention, it is provided that the at least one process state and/or a change in the at least one process state is displayed in the form of the electronic message.

It is thereby made possible for the user of the device to receive specific items of information regarding the at least one process state and/or regarding the change in the at least one process state.

In an embodiment example of the invention, it is provided that at least two algorithms can be used in parallel for the calculation of the actually present process state and/or the classification of the actually present process state.

It is thereby made possible on the one hand for the calculation and/or classification of the actually present process state to be more reliable because of additional items of information of the at least one further algorithm and/or on the other hand for it to be guaranteed that at least one algorithm images the process variable set in relation to the at least one actually present process state more optimally.

In an embodiment example of the invention, it is provided that, for the case where no measure is necessary or recommended in relation to the actually present process state because of its classification, the commands during the execution of the computer program by the computing unit prompt it either not to output a message or to generate an electronic message and output it by means of the output device, wherein the electronic message contains an item of information as to which of the possible process states that differ in relation to a process variable set is actually present and/or an item of information that no measure is necessary or recommended.

It is thereby made possible for the user not to be overloaded with items of information which can distract the user from handling the device.

It is also made possible to present the user of the device with a validation in the form of an electronic message which clarifies that the at least one actually present process state does not require any necessary measures on the part of the user.

In an embodiment example of the invention, it is provided that at least one additional parameter relates to an actual value of the associated process variable and/or to an actual value of the associated derived variable from at least one preceding moulding cycle of the moulding machine, wherein it is preferably provided that a historical progression of the actual value of the associated process variable and/or the actual value of the associated derived variable is calculated from a plurality of actual values of the associated process variable and/or from a plurality of actual values of the associated derived variable from a plurality of preceding moulding cycles.

It is thereby made possible for the at least one additional parameter to include items of information from preceding moulding cycles and/or to be already adapted to preceding moulding cycles.

Advantageously, at least one additional parameter is thus given, which is optimally adjusted to the moulding cycle to be considered on the basis of the items of information regarding the variables from the preceding moulding cycles.

Using the historical progression of the actual value of the associated process variable, a temporal sequence of the changes in the actual value of the associated process variable and/or derived variable is calculated.

A succession of different actual values of the associated process variable can be visualized using the items of information regarding the preceding moulding cycles.

In an embodiment example of the invention, it is provided that at least one additional parameter is selected from the list below (any desired combination is possible):
a target value of at least one process variable, optionally the process variable in relation to which the actually present process state is to be calculated,
a target value of at least one derived variable, optionally the derived variable in relation to which the actually present process state is to be calculated,
an actual value of at least one process variable from at least one preceding cycle,
an actual value of a derived variable from at least one preceding cycle,
a reference value of at least one process variable, optionally the process variable in relation to which the actually present process state is to be calculated,
a reference value of at least one derived variable, optionally the derived variable in relation to which the actually present process state is to be calculated,
a tolerance range of at least one process variable, optionally the process variable in relation to which the actually present process state is to be calculated,
a tolerance range of at least one derived variable, optionally the derived variable in relation to which the actually present process state is to be calculated,
an auxiliary variable, preferably a counter variable,
a geometric parameter of the production facility,
a geometric parameter of the moulding machine and/or optionally of the at least one peripheral device,
component-specific parameters of the moulding machine and/or optionally of the at least one peripheral device,
performance data of the moulding machine and/or optionally of the at least one peripheral device,
parameters of a raw material.

It is thereby made possible for the at least one additional parameter not to be limited to one type of parameter, but to offer information regarding different parameter types.

The geometric parameter of the production facility is generally as desired. This geometric parameter of the production facility particularly preferably relates to structural variables, such as for example the screw diameter.

In an embodiment example of the invention, it is provided that the at least one derived variable is calculated from the actual values of at least one process variable of a current moulding cycle and/or of past moulding cycles and optionally of the at least one additional parameter and/or in relation to a value relating to a drift.

The calculation of the at least one derived variable from at least one process variable also makes actual values and/or target values regarding this derived variable possible.

In an embodiment example of the invention, it is provided that the at least one derived variable is selected from the list below:
a value relating to a drift of a process variable,
a statistical coefficient of the actual values of a process variable of a current moulding cycle and/or of past moulding cycles.

In an embodiment example of the invention, it is provided that the at least one algorithm comprises at least one hypothesis, wherein the at least one hypothesis in relation to the actually present at least one process state and/or a change in the at least one process state represents a possible diagnosis in relation to a cause of the presence of the at least one process state and/or the change in the at least one process state.

It is thereby first made possible for the at least one process state to be checked for possible causes and, through the diagnosis of the process state, for it to be recognizable on what the actually present process state is substantiated.

For example, too high a temperature of machine components can be caused by too high an ambient temperature. This item of information is provided by the at least one hypothesis.

In an embodiment example of the invention, it is provided that the possible diagnosis can be generated by the at least one hypothesis on the basis of the at least one algorithm present and at least one event and/or can be modified depending on at least one preceding moulding cycle. It is thereby made possible for the diagnosis of the at least one process state to be regarded in relation to the actually present parameters and for a detailed cause of the actually present process state to be able to be indicated.

The hypotheses which guarantee a diagnosis of the actually present process state can be balanced by at least one parameter.

The at least one hypothesis can be altered over the temporal progression of several moulding cycles and/or adapted successively to a more applicable hypothesis.

In an embodiment example of the invention, it is provided that at least one electronic message can be displayed, which presents the at least one diagnosis in the form of an electronic message and/or which displays the applicability and/or non-applicability of the at least one hypothesis and/or the at least one process state.

It is thereby made possible for the hypotheses and their correctness also to be prepared optically for the user in addition to the visualization of the at least one process state. In addition, the user is informed about the process state.

In an embodiment example of the invention, it is provided that at least two hypotheses can be used and/or displayed in parallel for the diagnosis of the actually present at least one process state and/or a change in the at least one process state.

It is thereby made possible for at least two alternatives in the diagnosis of the at least one actually present process state to be prepared for the user of the device.

Furthermore, it is advantageous that in the combination of two hypotheses a more accurate exploration of the causes of the actually present process state is guaranteed.

In an embodiment example of the invention, it is provided that the electronic message is generated by the computing unit in relation to at least one of the possible process states with at least one fixed message element and at least one variable message element, wherein it is preferably provided that the at least one variable message element contains at least one numerical value of at least one process variable and/or at least one derived variable and/or at least one additional parameter or a graphic representation of a temporal progression of at least one numerical value of at least one process variable and/or at least one derived variable and/or at least one additional parameter.

A more flexible preparation of the data is thereby made possible and the items of information are structured to a greater extent for the user.

In an embodiment example of the invention, it is provided that the electronic message contains at least one numerical value of at least one process variable and/or at least one derived variable and/or at least one additional parameter.

A more precise information preparation is thereby made possible for the user by the electronic message.

In an embodiment example of the invention, it is provided that the electronic message contains a graphic representation of a temporal progression of at least one numerical value of at least one process variable and/or at least one derived variable and/or at least one additional parameter.

A user-friendly optical preparation of at least one numerical value is thereby made possible, which makes the historical progression of the at least one numerical value visible to the user at a glance.

In an embodiment example of the invention, it is provided that the electronic message contains at least one message element in the form of
a plain text notification and/or
a graphic or an image and/or
an acoustic notification and/or
a non-textual, visual notification.

It is thereby made possible for the user of the device to be made aware of the electronic message via several sensory perceptions and to have it available displayed in an optically appealing form which presents the data prepared visually.

The term production facility is to be distinguished from the term production site, which has a plurality of production facilities in a spatially outlined area (e.g. a production hall). The invention relates to one production facility, but can of course be used in any number of production facilities.

The moulding machine is preferably an injection-moulding machine, particularly preferably a plastic injection-moulding machine.

The at least one peripheral device is preferably a handling device (e.g. robot). The computing unit and/or the memory unit can be arranged in spatial unity with the production facility, preferably in structural unity with the moulding machine and/or with the optionally present at least one peripheral device (e.g. as part of a machine control of the production facility). The computing unit and/or the memory unit can, however, additionally or alternatively be arranged spatially distant from the production facility (cloud solution) or be located in a common (for example local) network with one or more production facilities.

The output device can have a screen and/or a signal-generating device for generating and emitting acoustic or visual signals. The output device can be formed as an operator interface of the production facility.

Embodiment examples of the invention are discussed with reference to the figures. There are shown in:

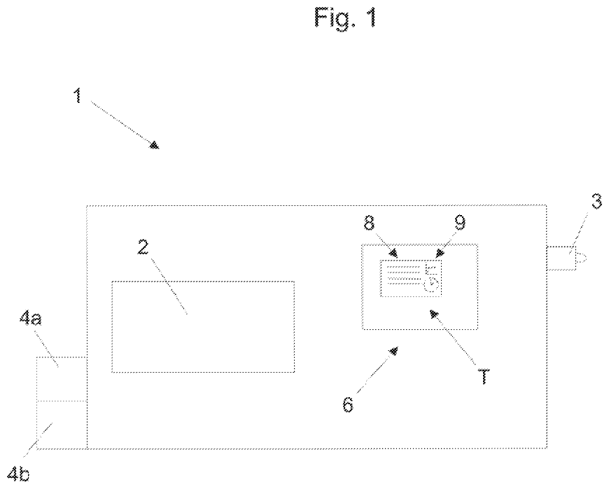

FIG. 1 a device for monitoring a production facility containing a moulding machine functioning in moulding cycles and optionally at least one peripheral device in a schematic view,

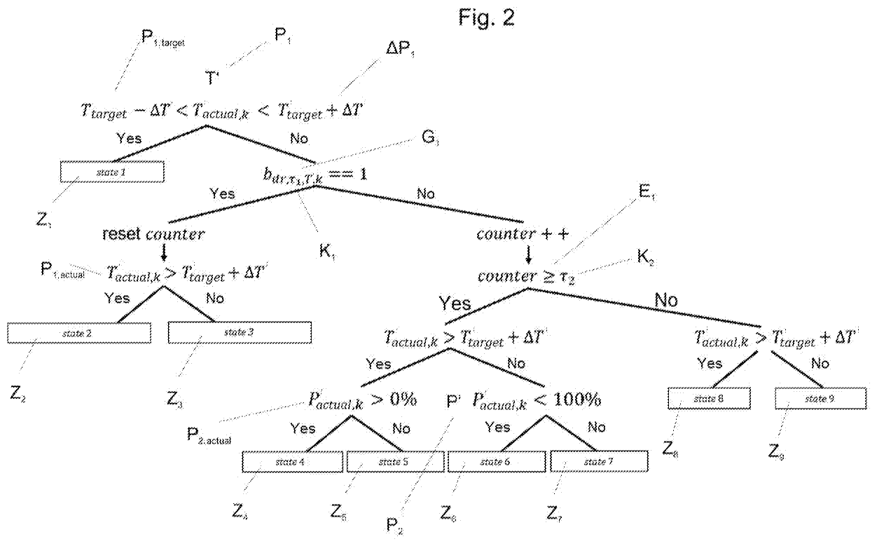

FIG. 2 an algorithm according to a first embodiment example,

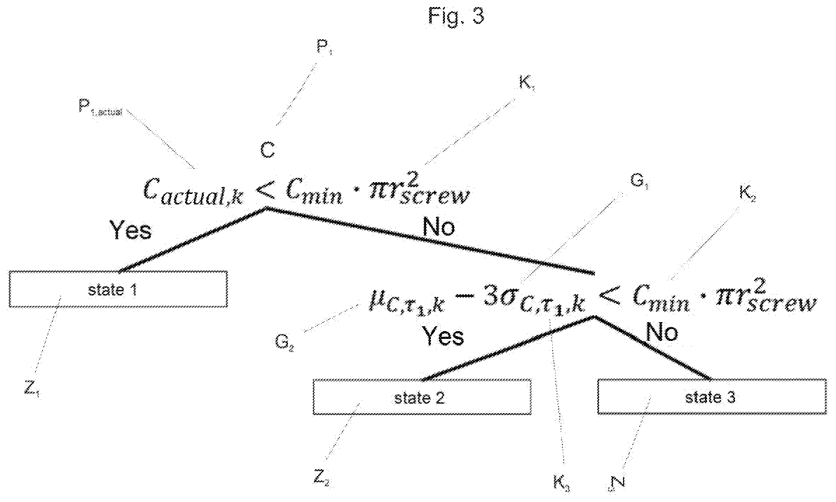

FIG. 3 an algorithm according to a second embodiment example,

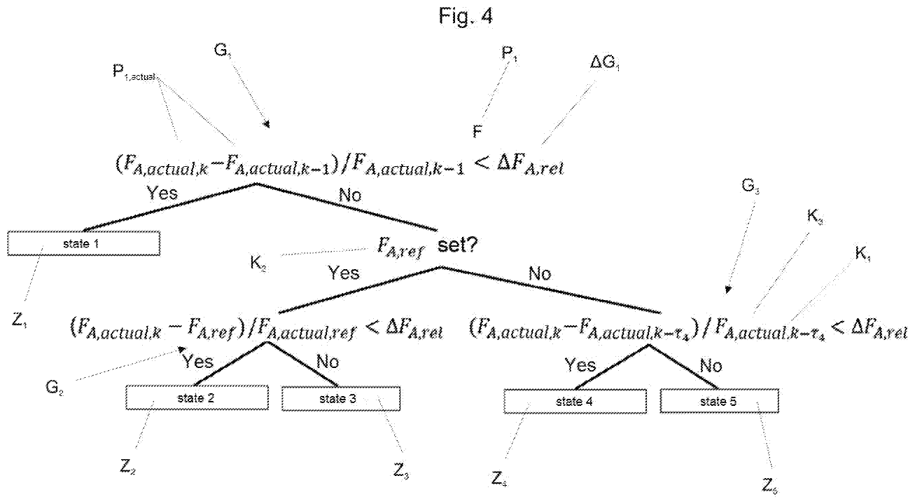

FIG. 4 an algorithm according to a third embodiment example,

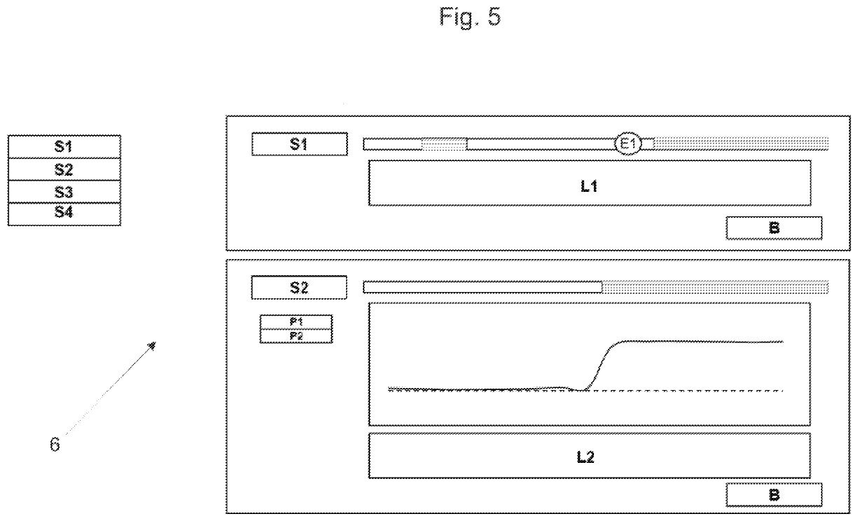

FIG. 5 an operator interface of the production facility.

FIG. 1 shows a production facility 1 with a computing unit 2 and a sensor 3. Two memory units 4a, 4b are arranged on a housing part of the production facility 1. A computer program product (not displayed in the representation for reasons of clarity) generates an electronic message T and sends it to an output device 6.

The output device 6 displays an electronic message T, comprising a fixed message element 8 and a variable message element 9. In a further embodiment example, the electronic message T displayed by the output device 6 can also have a different number of fixed message elements 8 and variable message elements 9 or one of these components can be dispensed with.

The form and position of the fixed message element 8 and the variable message element 9 are intrinsically as desired. However, a separate and clearly structured arrangement is particularly preferred, in order to guarantee the necessary items of information regarding the actually present process state Zₗ for the user at a glance in a visually appealing manner.

The output device 6 can be, for example, an operator interface (HMI) of the production facility 1, via which the items of information regarding the actually present process state Zₗ are visualized.

The variable message element 9 can contain, for example, actual values P_{1,actual}, P_{2,actual}, . . . , P_{m,actual} of the process variables P₁, P₂, . . . , Pₘ and/or actual values G_{1,actual}, G_{2,actual}, . . . , G_{n,actual} of the derived variables G₁, G₂, . . . , Gₙ.

FIG. 2 shows an algorithm A (represented here by way of example as a decision tree; this is not to be understood as limiting, it applies to all embodiment examples) in relation to the injection cylinder temperature of a plasticizing unit of a moulding machine formed as a plastic injection-moulding machine, wherein plastic granules are melted in the plasticizing unit.

The embodiment example comprises two process variables P₁, P₂, which represent the temperature T′ and the heating power P′ of a heating device of the plasticizing unit. Furthermore, T′_{target,k} represents a target value P_{1,target} of the associated process variable P₁. T′_{actual,k} and P′_{actual,k} represent two actual values of the associated process variables P₁ and P₂ respectively.

A tolerance range of the process variable ΔP₁ is given by the limit value for an admissible temperature deviation ΔT′. Two additional parameters K₁₁, K₁₂ comprise a relative index T₁ of the first moulding cycle for an observation window and a limit value T₂ for a counter.

The process variable set P (not represented for reasons of clarity) is formed by the two process variables P₁, P₂.

In the present case, nine different process states Z₁, Z₂, Z₃, Z₄, Z₅, Z₆, Z₇, Z₈, Z₉ are possible.

In general, a process state Z₁, Z₂, . . . , Z_{q} need not be assigned to every process variable P₁, P₂, . . . , Pₘ and/or derived variable G₁, G₂, . . . , Gₙ.

The actually present process state Zₗ is determined by execution of the algorithm Aₛ and prepared, together with an associated hypothesis Hᵣ (not represented for reasons of clarity), in an electronic message T (not represented for reasons of clarity).

The statements below regarding the electronic message T apply to all embodiment examples.

The electronic message T can additionally comprise, on the basis of the hypotheses Hᵣ, details such as potential explanations for a process state Z₁, Z₂, . . . , Z_{q} and instructions for the operator. This guarantees an assessment of the quality of the process setting, of the process state Z₁, Z₂, . . . , Z_{q}, of material states (for example change in the supplied material), of influences of unmeasured disturbance variables (for example ambient air, draughts, etc.) as well as of states of elements of the production facility, such as for example a problem closing the non-return valve.

Regarding the actually present process state Zₗ, graphs such as for example the temporal progression (shot-dependent and/or time-dependent) of selected process variables P₁, P₂, . . . , Pₘ and/or any desired parameter can also be visualized.

Furthermore, the electronic message T can be displayed in conjunction with images (for example of production facility components on which there is a problem) or acoustic notifications in the form of spoken text, audible warnings and/or music. Optical notifications in the form of warning lights and/or light projections are also possible.

The electronic message T can also be presented in the form of a partially and/or fully automatic messaging of defined people, departments and/or institutions. Interventions in the production such as selection of rejects and/or interruption in production can likewise be displayed in conjunction with the electronic message T.

The electronic message T can in addition be formed on the basis of artificial intelligence and/or can learn through expert systems from big data. A guided handling recommendation for the operator is likewise possible according to the invention, wherein an expert system additionally learns from the guidance of the action to remedy errors.

A derived variable G₁ is indicated by a Boolean variable b_{dr,r1,T,k}, the value of which indicates whether a drift of the process variable P₁ of the temperature T′ is present in the current moulding cycle, wherein an observation window of the variable T₁ of the moulding cycles for the measured temperature actual value T′_{actual,k} is used for the assessment of the presence of a drift.

The auxiliary variable k relates to the cycle counter value k for the current moulding cycle.

A counter counts the number of moulding cycles k using the auxiliary variable k and the exceeding of the limit value T₂ for the counter corresponds to an event E₁. The type of event E₁, E₂, . . . , Eₒ is in general as desired. An event E₁, E₂, . . . , Eₒ can also be a start of the facility, a change in target values P_{1,target}, P_{2,target}, . . . , P_{m,target} by a user, exceeding of or failure to meet a target value P_{1,target}, P_{2,target}, . . . , P_{m,target} of the process variable P₁, P₂, . . . , Pₘ, etc.

### Process States and Associated Possible Notifications:

| | |
|---|---|
| Process | The current temperature lies within the tolerance range. |
| state Z₁ | Possible notifications: |
| | None |
| | “The temperature in zone <5> has been stable |
| | since <1.4.2019>” |
| Process | The current temperature exceeds the target value by more |
| state Z₂ | than the limit value for the admissible temperature |
| | deviation. |
| | Possible notifications: |
| | “The set temperature has not yet been achieved” |
| | “Heating zone <5>: temperature not achieved” |
| Process | The current temperature fails to meet the target value |
| state Z₃ | by more than the limit value for the admissible |
| | temperature deviation. |
| | Possible notification: |
| | “The set temperature has not yet been achieved” |
| | “Heating zone <5>: temperature not achieved” |
| Process | The temperature has been almost constantly above the |
| state Z₄ | target value by at least the value ΔT for at least τ₂ |
| | cycles. Nevertheless, the heater is still |
| | active (P_{actual, k} > 0) |
| | Possible notifications: |
| | “Check heater regulator setting” |
| | “Call service engineer” |
| Process | The temperature has been almost constantly above the |
| state Z₅ | target value by at least the value ΔT for at least τ₂ |
| | cycles. |
| | Possible notifications: |
| | “The set temperature of <240° C.> is exceeded by <5° C.>. |
| | Possible cause: a high shear energy is introduced |
| | during the plasticizing, or influencing by adjacent |
| | heating zone” |
| Process | The temperature has been almost constantly below the |
| state Z₆ | target value by at least the value ΔT for at least τ₂ |
| | cycles. The heater is not heating at full power. |
| | Possible notifications: |
| | “The set temperature of <240° C.> has failed to |
| | be met by <5° C.>. The facility does not use the |
| | maximum possible heating power in order to achieve |
| | the temperature target value. Please check regulator |
| | parameters or notify service department” |
| Process | The temperature has been almost constantly below the |
| state Z₇ | target value by at least the value ΔT for at least τ₂ |
| | cycles. The heater is heating at full power. |
| | Possible notifications: |
| | “The set target temperature cannot be achieved, |
| | the heating power is too low” |
| Process | The temperature has been almost constantly above the |
| state Z₈ | target value by at least the value ΔT for fewer than τ₂ |
| | cycles. |
| | Possible notifications: |
| | None |
| | “Temperature in zone <5> too high” |
| Process | The temperature has been almost constantly below the |
| state Z₉ | target value by at least the value ΔT for fewer than τ₂ |
| | cycles. |
| | Possible notifications: |
| | None |
| | “Temperature in zone <5> too low” |

FIG. 3 shows an algorithm Aₛ in relation to the monitoring of the melt cushion of a plasticizing unit of a moulding machine formed as a plastic injection-moulding machine, wherein plastic granules are melted in the plasticizing unit. The process variable P₁ represents the residual melt cushion C of the melted plastic granules. C_{actual,K} represents the actual value P_{1,actual} of the associated process variable P₁. Two derived variables G₁, G₂ represent the distribution of the residual melt cushion σ_{c,r1,k}, and the average value of the residual melt cushion μ_{c,r1,k}, which are preferably determined from the preceding moulding cycles.

Three additional parameters K₁₁, K₁₂, K₁₃ represent a radius of the screw r_{screw}, a minimum admissible residual melt cushion Cₘᵢₙ and a relative index T₁ of the first moulding cycle for the observation window.

The process variable set P (not represented for reasons of clarity) is formed by the two process variables P₁ and the two derived variables G₁, G₂.

In general, target values G_{1,target}, G_{2,target}, . . . , G_{n,target} (not represented in the Figs.) and/or actual values G_{1,actual}, G_{2,actual}, . . . , G_{n,actual} (not represented in the Figs.) of derived variables G₁, G₂, . . . , Gₙ can also be connected with the derived variables G₁, G₂, . . . , Gₙ.

The calculation with the process parameters by the execution of the algorithm Aₛ distinguishes between three possible process states Z₁, Z₂, Z₃ here.

### Process States and Associated Possible Notifications:

| | |
|---|---|
| Process | The current residual melt cushion fails to meet a |
| state Z₁ | critical value. |
| | Possible notifications: |
| | “Residual melt cushion too small” |
| Process | The current residual melt cushion is close to the |
| state Z₂ | critical value and could fail to meet it in one |
| | of the subsequent cycles. |
| | Possible notifications: |
| | “Residual melt cushion too small” |
| Process | The residual melt cushion is within an acceptable |
| state Z₃ | range. |
| | Possible notifications: |
| | None |

FIG. 4 shows an algorithm Aₛ in relation to the ejector force of an ejector device of a moulding machine. The process variable P₁ represents the ejector force F. Three derived variables G₁, G₂, G₃ represent a relative change in the ejector force compared with a value of the last moulding cycle (F_{A,actual,k}−F_{A,k-1})/F_{A,actual,k-1}, a relative change in the ejector force compared with a fixed reference value (F_{A,actual,k}−F_{A,ref})/F_{A,actual,ref} and a relative change in the ejector force compared with the sliding reference value (F_{A,actual,k}−F_{A,actual,k-r4})/F_{A,actual,k-r4}.

The actual value P_{1,actual} of the associated process variables P₁ is given by the measured maximum ejector force F_{A,actual} in the respective moulding cycle k, wherein the number of cycles k represents an auxiliary variable.

The admissible relative change in the ejector force ΔF_{A,rel} represents the tolerance range of the derived variable ΔG₁. Three additional parameters K₁, K₂, K₃ represent a relative index T₄ of the comparison cycle, a fixed reference value for a maximum ejector force F_{A,ref} and a sliding reference value for the maximum ejector force F_{A,actual,k-r4}.

The process variable set P (not represented for reasons of clarity) is formed by the process variable P₁ and the three derived variables G₁, G₂, G₃.

The calculation with the process parameters by the execution of the algorithm Aₛ distinguishes between five possible process states Z₁, Z₂, Z₃, Z₄, Z₅ here. One hypothesis H₁, H₂, H₃, H₄, H₅, not represented, for the diagnosis is present for each of these five possible process states of this process variable set P.

### Process States and Associated Possible Notifications:

| | |
|---|---|
| Process | Considerable increase in the ejector force |
| state Z₁ | compared with the preceding cycle |
| | Possible notifications: |
| | The maximum value of the ejector force has |
| | increased by <30>% in comparison with the last shot. |
| Process | Considerable increase in the ejector force compared |
| state Z₂ | with the reference cycle |
| | Possible notifications: |
| | The maximum value of the ejector force has |
| | increased by <30>% in comparison with the reference |
| | shot <10534>. |
| Process | Ejector force within the admissible range |
| state Z₃ | Possible notifications: |
| | None |
| Process | Considerable increase in the ejector force within |
| state Z₄ | the last <2500> cycles |
| | Possible notifications: |
| | The maximum value of the ejector force has |
| | increased by <30>% within the last <2500> cycles. |
| Process | Ejector force within the admissible range |
| state Z₅ | Possible notifications: |
| | None |

FIG. 5 schematically shows an embodiment example of an operator interface of an output device 6 for the output of electronic messages T.

The areas S₁ to S₄ contain electronic messages T (not represented for reasons of clarity) for the current moulding cycle in short form regarding actually present process states Z₁, Z₂, . . . , Z_{q} in each case in relation to four different algorithms A₁, A₂, A₃, A₄. Different process states Z₁, Z₂, . . . , Z_{q} are allocated to each of the four different algorithms A₁, A₂, A₃, A₄ (with the result that a process state Zₛₗ would actually have to be referred to in relation to an algorithm Aₛ, wherein only Zₗ is referred to in the present disclosure, however, for the sake of simplicity).

According to algorithm Aₛ, different numbers of process states Z_{q} can be present, with the result that “q” can have different values for different algorithms A₁, A₂, . . . , Aₜ.

At the bottom right, a button B is shown, which makes it possible for the user to open windows for input and/or for further generation of information.

The areas S₁ to S₄ at the same time act as buttons for opening detailed items of information about the respective process state Zₗ. The detailed items of information regarding the process states Z₁ and Z₂ are visible by way of example in the drawing. The detailed items of information contain, in addition to the electronic messages T in short form S₁, S₂, a more detailed description L₁, L₂ as well as a progress bar, which presents the temporal progression of the non-entry or entry of the allocated state in the form of different colours.

The progress bar has a starting point, given by a starting time point or a first cycle number, and presents the temporal progression of the allocated state up to an end point, given by a current time point or a current cycle number. The occurrence of an event E₁ is also marked by way of example in the progress bar.

An event E₁, E₂, . . . , Eₒ can be e.g. a change in target value by the user, the input of a new target value data set by the user, an interruption in operation or the like.

The areas P1, P2 represented underneath the electronic message T in short form S₂ additionally contain selection fields for the two process variables P₁ and P₂, with which the user can select which of the two process variables P₁ and P₂ a diagram is to be represented for.

The temporal progression of one of the actual values (P_{1,actual}, P_{2,actual}) and the allocated target value (P_{1,target}, P_{2,target}) is represented in the diagram. Each data point of the curve is allocated to a moulding cycle of the moulding machine.

In this example, electronic messages T are displayed regarding those four process states Z₁, Z₂, Z₃, Z₄ which have occurred at least once in the observation period (in the space of the starting time point and the current time point) or in the observation cycle range (in the space of the first cycle number and the current cycle number).

The observation range and/or the observation period can be chosen by the user. It is thus also possible to analyse historical data with respect to the process states Z₁, Z₂, Z₃, Z₄ that have occurred. The possibility of automatically updating the display after conclusion of a new moulding cycle can likewise be set by the user.

### LIST OF REFERENCE NUMBERS

1 production facility
2 computing unit
3 sensor
4a, 4b memory units
5 computer program
6 output device
8 fixed message element
9 variable message element
P process variable set
P₁, P₂, . . . , Pₘ process variables
G₁, G₂, . . . , Gₙ derived variables
E₁, E₂, . . . , Eₒ event
H₁, H₂, . . . , Hᵣ hypothesis
T electronic message
K₁, K₂, . . . , Kᵥ additional parameter
P_{1,actual}, P_{2,actual}, . . . , P_{m,actual} actual values of process variables
P_{1,target}, P_{2,target}, . . . , P_{m,target} target values of process variables
G_{1,actual}, G_{2,actual}, . . . , G_{n,actual} actual values of derived variables
G_{1,target}, G_{2,target}, . . . , G_{n,target} target values of derived variables
ΔP₁, ΔP₂, . . . , ΔPₘ tolerance ranges of process variables
ΔG₁, ΔG₂, . . . , ΔGₙ tolerance ranges of derived variables
P_{1,ref}, P_{2,ref}, . . . , P_{m,ref} reference values of process variables
G_{1,ref}, G_{2,ref}, . . . , G_{n,ref} reference values of derived variables
Z₁, Z₂, . . . , Z_{q} process states
A₁, A₂, . . . , Aₜ algorithms

1. A device for monitoring a production facility containing a moulding machine functioning in moulding cycles and optionally at least one peripheral device, with:
a computing unit,
at least one sensor, by means of which at least one actual value (P_{1,actual}, P_{2,actual}, . . . , P_{m,actual}) of at least one process variable (P₁, P₂, . . . , Pₘ) of the production facility can be determined in time-continuous or time-discrete manner, wherein the at least one sensor, is in or can be brought into data connection with the computing unit,
a memory unit, which is in or can be brought into data connection with the computing unit, wherein a computer program containing commands is stored in the memory unit,
an output device, with which the computing unit is in or can be brought into data connection,
wherein,
in a memory unit which is in or can be brought into data connection with the computing unit,
in relation to at least one process variable set, comprising at least two different process variables (P₁, P₂, . . . , Pₘ) of the production facility or at least one process variable (P₁, P₂, . . . , Pₘ) with at least one derived variable (G₁, G₂, . . . , Gₙ), in each case at least three possible process states (Z₁, Z₂, . . . , Z_{q}) of the production facility are stored and, in relation to each process variable set, at least one algorithm (A₁, A₂, . . . , Aₜ) is stored by which, using actual values (P_{1,actual}, P_{2,actual}, . . . , P_{m,actual}) of at least two process variables (P₁, P₂, . . . , Pₘ) or one actual value (P_{1,actual}, P_{2,actual}, . . . , P_{m,actual}) of at least one process variable (P₁, P₂, . . . , Pₘ) and one actual value (G_{1,actual}, G_{2,actual}, . . . , G_{n,actual}) of at least one derived variable (G₁, G₂, . . . , Gₙ) and at least one additional parameter (K₁, K₂, . . . , Kᵥ) which is different from the actual value (P_{1,actual}, P_{2,actual}, . . . , P_{n,actual}) of the respective process variable (P₁, P₂, . . . , Pₘ) and from the actual value (G_{1,actual}, G_{2,actual}, . . . , G_{n,actual}) of the respective derived variable (G₁, G₂, . . . , Gₙ), it can be calculated which of the possible process states (Z₁, Z₂, . . . , Z_{q}) that differ in relation to the respective process variable set (P) is actually present,
the possible process states (Z₁, Z₂, . . . , Z_{q}) that differ in relation to the respective process variable set (P) are classified according to whether measures which bring about an alteration of at least one process variable (P₁, P₂, . . . , Pₘ) and/or at least one derived variable (G₁, G₂, . . . , Gₙ) are necessary or recommended, wherein, in relation to each process variable set, at least one process state (Z₁, Z₂, . . . , Z_{q}) is classified such that no measures are necessary or recommended and at least one process state (Z₁, Z₂, . . . , Z_{q}) is classified such that measures are necessary or recommended,
the commands during the execution of the computer program by the computing unit prompt it
to execute, in relation to the respective process variable set, the associated at least one algorithm (A₁, A₂, . . . , Aₜ) and thus, using actual values (P_{1,actual}, P_{2,actual}, . . . , P_{m,actual}) of the at least two process variables (P₁, P₂, . . . , Pₘ) or the actual value (P_{1,actual}, P_{2,actual}, . . . , P_{m,actual}) of the at least one process variable (P₁, P₂, . . . , Pₘ) and the actual value (G_{1,actual}, G_{2,actual}, . . . , G_{m,actual}) of the at least one derived variable (G₁, G₂, . . . , Gₙ) and the at least one additional parameter (K₁, K₂, . . . , Kᵥ), to calculate which of the possible process states (Z₁, Z₂, . . . , Z_{q}) of the production facility that differ in relation to the respective process variable set is actually present and
to check whether the actually present process state (Z₁, Z₂, . . . , Z_{q}) is classified as such a process state (Z₁, Z₂, . . . , Z_{q}) for which a measure which brings about an alteration of the respective process variable set is necessary or recommended,
for the case where a measure is necessary or recommended in relation to the actually present process state (Z₁, Z₂, . . . , Z_{q}) because of its classification, to generate an electronic message (T) depending on the calculated process state (Z₁, Z₂, . . . , Z_{q}) and to output it by means of the output device.

2. The device according to claim 1, wherein the electronic message contains an item of information as to:
which measure is necessary or recommended and/or
which of the possible process states (Z₁, Z₂, . . . , Z_{q}) that differ in relation to the process variable set is actually present.

3. The device according to claim 1, wherein at least one additional parameter (K₁, K₂, . . . , Kᵥ) and/or at least one process variable (P₁, P₂, . . . , Pₘ) and/or at least one derived variable (G₁, G₂, . . . , Gₙ) from at least one preceding moulding cycle can be used for the execution of the at least one algorithm (A₁, A₂, . . . , Aₜ).

4. The device according to claim 1, wherein the at least one process state (Z₁, Z₂, . . . , Z_{q}) and/or a change in the at least one process state (Z₁, Z₂, . . . , Z_{q}) is displayed in the form of the electronic message.

5. The device according to claim 1, wherein at least two algorithms can be used in parallel for the calculation of the actually present process state (Z₁, Z₂, . . . , Z_{q}) and/or the classification of the actually present process state (Z₁, Z₂, . . . , Z_{q}).

6. The device according to claim 1, wherein, for the case where no measure is necessary or recommended in relation to the actually present process state (Z₁, Z₂, . . . , Z_{q}) because of its classification, the commands during the execution of the computer program (5) by the computing unit prompt it either not to output a message or to generate an electronic message and output it by means of the output device, wherein the electronic message contains an item of information as to which of the possible process states (Z₁, Z₂, . . . , Z_{q}) that differ in relation to the respective process variable set is actually present and/or an item of information that no measure is necessary or recommended.

7. The device according to claim 1, wherein at least one additional parameter (K₁, K₂, . . . , Kᵥ) relates to an actual value (P_{1,actual}, P_{2,actual}, . . . , P_{m,actual}) of the associated process variable (P₁, P₂, . . . , Pₘ) and/or to an actual value (G_{1,actual}, G_{2,actual}, . . . , G_{n,actual}) of the associated derived variable (G₁, G₂, . . . , Gₙ) from at least one preceding moulding cycle of the moulding machine, wherein it is preferably provided that a historical progression of the actual value (P_{1,actual}, P_{2,actual}, . . . , P_{m,actual}) of the associated process variable (P₁, P₂, . . . , Pₘ) and/or the actual value (G_{1,actual}, G_{2,actual}, . . . , G_{n,actual}) of the associated derived variable (G₁, G₂, . . . , Gₙ) is calculated from a plurality of actual values (P_{1,actual}, P_{2,actual}, . . . , P_{m,actual}) of the associated process variable (P₁, P₂, . . . , Pₘ) and/or from a plurality of actual values (G_{1,actual}, G_{2,actual}, . . . , G_{n,actual}) of the associated derived variable (G₁, G₂, . . . , Gₙ) from a plurality of preceding moulding cycles.

8. The device according to claim 1, wherein at least one additional parameter (K₁, K₂ . . . , Kᵥ) is selected from the list below:
a target value (P_{1,target}, P_{2,target}, . . . , P_{m,target}) of at least one process variable (P₁, P₂, . . . , Pₘ), optionally the process variable (P₁, P₂, . . . , Pₘ) in relation to which the actually present process state (Z₁, Z₂, . . . , Z_{q}) is to be calculated,
a target value (G_{1,target}, G_{2,target}, . . . , G_{n,target}) of at least one derived variable (G₁, G₂, . . . , Gₙ), optionally the derived variable (G₁, G₂, . . . , Gₙ) in relation to which the actually present process state (Z₁, Z₂, . . . , Z_{q}) is to be calculated,
an actual value (P_{1,actual}, P_{2,actual}, . . . , P_{m,actual}) of at least one process variable (P₁, P₂, . . . , Pₘ) from at least one preceding cycle,
an actual value (G_{1,actual}, G_{2,actual}, . . . , G_{m,actual}) of a derived variable (G₁, G₂, . . . , Gₙ) from at least one preceding cycle,
a reference value (P_{1,ref}, P_{2,ref}, . . . , P_{m,ref}) of at least one process variable (P₁, P₂, . . . , Pₘ), optionally the process variable (P₁, P₂, . . . , Pₘ) in relation to which the actually present process state (Z₁, Z₂, . . . , Z_{q}) is to be calculated,
a reference value (G_{1,ref}, G_{2,ref}, . . . , G_{n,ref}) of at least one derived variable (G₁, G₂, . . . , Gₙ), optionally the derived variable (G₁, G₂, . . . , Gₙ) in relation to which the actually present process state (Z₁, Z₂, . . . , Z_{q}) is to be calculated,
a tolerance range (ΔP₁, ΔP₂, . . . , ΔPₘ) of at least one process variable (P₁, P₂, . . . , Pₘ), optionally the process variable (P₁, P₂, . . . , Pₘ) in relation to which the actually present process state (Z₁, Z₂, . . . , Z_{q}) is to be calculated,
a tolerance range (ΔG₁, ΔG₂, . . . , ΔGₙ) of at least one derived variable (G₁, G₂, . . . , Gₙ), optionally the derived variable (G₁, G₂, . . . , Gₙ) in relation to which the actually present process state (Z₁, Z₂, . . . , Z_{q}) is to be calculated,
an auxiliary variable, preferably a counter variable,
a geometric parameter of the moulding machine and/or optionally of the at least one peripheral device,
component-specific parameters of the moulding machine and/or optionally of the at least one peripheral device,
performance data of the moulding machine and/or optionally of the at least one peripheral device,
parameters of a raw material.

9. The device according to claim 1, wherein the at least one derived variable (G₁, G₂, . . . , Gₙ) is calculated from the actual values (P_{1,actual}, P_{2,actual}, . . . , P_{m,actual}) of at least one process variable (P₁, P₂, . . . , Pₘ) of a current moulding cycle and/or of past moulding cycles and optionally of the at least one additional parameter (K₁, K₂, . . . , Kᵥ) and/or in relation to a value relating to a drift.

10. The device according to claim 9, wherein the at least one derived variable (G₁, G₂, . . . , Gₙ) is selected from the list below:
a value relating to a drift of a process variable (P₁, P₂, . . . , Pₘ),
a statistical coefficient of the actual values of a process variable (P₁, P₂, . . . , Pₘ) of a current moulding cycle and/or of past moulding cycles.

11. The device according to claim 1, wherein the at least one algorithm (A₁, A₂, . . . , Aₜ) comprises at least one hypothesis (H₁, H₂, . . . , Hᵣ), wherein the at least one hypothesis (H₁, H₂, . . . , Hᵣ) in relation to the actually present at least one process state (Z₁, Z₂, . . . , Z_{q}) and/or the change in the at least one process state (Z₁, Z₂, . . . , Z_{q}) represents a possible diagnosis in relation to a cause of the presence of the at least one process state (Z₁, Z₂, . . . , Z_{q}) and/or the change in the at least one process state (Z₁, Z₂, . . . , Z_{q}).

12. The device according to claim 11, wherein the possible diagnosis can be generated by the at least one hypothesis (H₁, H₂, . . . , Hᵣ) on the basis of the at least one algorithm present (A₁, A₂, . . . , Aₜ) and
at least one event (E₁, E₂, . . . , Eₒ)
and/or can be modified depending on at least one preceding moulding cycle.

13. The device according to claim 11, wherein at least one electronic message can be displayed, which presents the at least one diagnosis in the form of an electronic message and/or which displays the applicability and/or non-applicability of the at least one hypothesis (H₁, H₂, . . . , Hᵣ) and/or the at least one process state (Z₁, Z₂, . . . , Z_{q}).

14. The device according to claim 11, wherein at least two hypotheses (H₁, H₂, . . . , Hᵣ) can be used and/or displayed in parallel for the diagnosis of the actually present at least one process state (Z₁, Z₂, . . . , Z_{q}) and/or a change in the at least one process state (Z₁, Z₂, . . . , Z_{q}).

15. The device according to claim 1, wherein the electronic message is generated by the computing unit in relation to at least one of the possible process states (Z₁, Z₂, . . . , Z_{q}) with at least one fixed message element and at least one variable message element, wherein it is preferably provided that the at least one variable message element contains at least one numerical value of at least one process variable (P₁, P₂, . . . , Pₘ) and/or at least one derived variable (G₁, G₂, . . . , Gₙ) and/or at least one additional parameter (K₁, K₂, . . . , Kₙ) or a graphic representation of a temporal progression of at least one numerical value of at least one process variable (P₁, P₂, . . . , Pₘ) and/or at least one derived variable (G₁, G₂, . . . , Gₙ) and/or at least one additional parameter (K₁, K₂, . . . , Kᵥ).

16. Device according to claim 1, wherein the electronic message contains at least one numerical value of at least one process variable (P₁, P₂, . . . , Pₘ) and/or at least one derived variable (G₁, G₂, . . . , Gₙ) and/or at least one additional parameter (K₁, K₂, . . . , Kᵥ).

17. The device according to claim 1, wherein the electronic message contains a graphic representation of a temporal progression of at least one numerical value of at least one process variable (P₁, P₂, . . . , Pₘ) and/or at least one derived variable (G₁, G₂, . . . , Gₙ) and/or at least one additional parameter (K₁, K₂, . . . , Kᵥ).

18. The device according to claim 1, wherein the electronic message contains at least one message element in the form of
a plain text notification and/or
a graphic or an image and/or
an acoustic notification and/or
a non-textual, visual notification.

19. A production facility with a moulding machine functioning in moulding cycles and optionally at least one peripheral device and a device according to claim 1.

20. A computer program product, comprising commands which, when executed by a computing unit, prompt it, for a production facility containing a moulding machine functioning in moulding cycles and optionally at least one peripheral device,
from a memory unit which is in or can be brought into data connection with the computing unit, in relation to at least one process variable set of the production facility, to retrieve in each case at least three possible process states (Z₁, Z₂, . . . , Z_{q}) of the production facility and, in relation to each process variable set, to retrieve at least one algorithm (A₁, A₂, . . . , Aₜ) by which, using actual values (P_{1,actual}, P_{2,actual}, . . . , P_{m,actual}) of at least two process variables (P₁, P₂, . . . , Pₘ) or one actual value (P_{1,actual}, P_{2,actual}, . . . , P_{m,actual}) of at least one process variable (P₁, P₂, . . . , Pₘ) and one actual value (G_{1,actual}, G_{2,actual}, . . . , G_{n,actual}) of the respective derived variable (G₁, G₂, . . . , Gₙ) and at least one additional parameter (K₁, K₂, . . . , Kᵥ) which is different from the actual value (P_{1,actual}, P_{2,actual}, . . . , P_{m,actual}) of the respective process variable (P₁, P₂, . . . , Pₘ) and from the actual value (G_{1,actual}, G_{2,actual}, . . . , G_{n,actual}) of the respective derived variable (G₁, G₂, . . . , Gₙ), it can be calculated which of the possible process states (Z₁, Z₂, . . . , Z_{q}) of the production facility that differ in relation to the respective process variable set (P) is actually present, wherein the possible process states (Z₁, Z₂, . . . , Z_{q}) that differ in relation to the respective process variable set are classified according to whether measures which bring about an alteration of the respective process variable (P₁, P₂, . . . , Pₘ) and/or derived variable (G₁, G₂, . . . , Gₙ) are necessary or recommended, wherein, in relation to each process variable set (P), at least one process state (Z₁, Z₂, . . . , Z_{q}) is classified such that no measures are necessary or recommended and at least one process state (Z₁, Z₂, . . . , Z_{q}) is classified such that measures are necessary or recommended,
in relation to at least one process variable set, to execute the associated at least one algorithm (A₁, A₂, . . . , Aₜ) and thus, taking into account the actual values (P_{1,actual}, P_{2,actual}, . . . , P_{m,actual}) of the at least two process variables (P₁, P₂, . . . , Pₘ) or the actual value (P_{1,actual}, P_{2,actual}, . . . , P_{m,actual}) of the at least one process variable (P₁, P₂, . . . , Pₘ) and the actual value (G_{1,actual}, G_{2,actual}, . . . , G_{m,actual}) of the respective derived variable (G₁, G₂, . . . , Gₙ) and at least one additional parameter (K₁, K₂, . . . , Kᵥ), to calculate which of the possible process states (Z₁, Z₂, . . . , Z_{q}) that differ in relation to the respective process variable set (P) is actually present and
to check whether the actually present process state (Z₁, Z₂, . . . , Z_{q}) is classified as such a process state (Z₁, Z₂, . . . , Z_{q}) for which a measure which brings about an alteration of the respective process variable (P₁, P₂, . . . , Pₘ) and/or derived variable (G₁, G₂, . . . , Gₙ) is necessary or recommended,
for the case where a measure is necessary or recommended in relation to the actually present process state (Z₁, Z₂, . . . , Z_{q}) because of its classification, to generate an electronic message (T) depending on the calculated process state (Z₁, Z₂, . . . , Z_{q}) and to output it by means of the output device (6), wherein it is preferably provided that the electronic message (T) contains an item of information as to which of the possible process states (Z₁, Z₂, . . . , Z_{q}) that differ in relation to the process variable set (P) is actually present.

21. A method for monitoring a production facility containing a moulding machine functioning in moulding cycles and optionally at least one peripheral device, wherein, by means of a computing unit,
in relation to at least one process variable set of the production facility, taking into account actual values (P_{1,actual}, P_{2,actual}, . . . , P_{n,actual}) of at least two process variables (P₁, P₂, . . . , Pₘ) or one actual value (P_{1,actual}, P_{2,actual}, . . . , P_{n,actual}) of at least one process variable (P₁, P₂, . . . , Pₘ) and one actual value (G_{1,actual}, G_{2,actual}, . . . , G_{n,actual}) of a respective derived variable (G₁, G₂, . . . , Gₙ) and at least one additional parameter (K₁, K₂, Kᵥ), it is calculated which of the possible process states (Z₁, Z₂, . . . , Z_{q}) of the production facility that differ in relation to the respective process variable set is actually present and
it is checked whether the actually present process state (Z₁, Z₂, . . . , Z_{q}) is classified as such a process state (Z₁, Z₂, . . . , Z_{q}) for which a measure which brings about an alteration of the respective process variable (P₁, P₂, . . . , Pₘ) and/or derived variable (G₁, G₂, . . . , Gₙ) is necessary or recommended,
for the case where a measure is necessary or recommended in relation to the actually present process state (Z₁, Z₂, . . . , Z_{q}) because of its classification, to generate an electronic message (T) depending on the calculated process state (Z₁, Z₂, . . . , Z_{q}) and to output it by means of the output device (6), wherein it is preferably provided that the electronic message (T) contains an item of information as to which of the possible process states (Z₁, Z₂, . . . , Z_{q}) that differ in relation to the process variable set is actually present.
